(19) United States
(12) Patent Application Publication
(10) Pub. No.: US 2023/0324719 A1
(43) Pub. Date: Oct. 12, 2023

(54) SUN SCREEN DEVICE

(71) Applicant: OPTREL HOLDING AG, Waltwil (CH)

(72) Inventors: Marco KOCH, Muehlrueti (CH); Daniel BLOECHLINGER, Gallenkappel (CH); Martin ESPOSITO, Rapperswil (CH)

(21) Appl. No.: 18/022,462

(22) PCT Filed: Aug. 11, 2021
(86) PCT No.: PCT/EP2021/072383

§ 371 Date: Feb. 21, 2023

(30) Foreign Application Priority Data
Aug. 21, 2020 (EP) 20192151.7

(51) Int. Cl. G02C 7/10

(52) U.S. Cl. CPC G02C 7/102; G02C 7/101

(57) ABSTRACT

A sun protection device, in particular a pair of sunglasses, comprises at least one optical sun protection filter having at least one liquid crystal cell, wherein the optical sun protection filter comprises at least one photochromatic protection element whose transmittance changes in particular at least depending on the solar irradiation.

### STATE OF THE ART

The invention relates to a sun protection device, in particular sunglasses.

Sunglasses with at least one optical a comprising at least one liquid crystal cell are already known from EP 3 223 067.

The task of the invention is in particular to provide a generic device with improved properties in terms of comfort and usability. This task is solved, according to the invention, by the features of claim 1, while advantageous embodiments and further developments of the invention are described in the subclaims.

### ADVANTAGES OF THE INVENTION

The invention is based on a sun protection device, in particular sunglasses, with at least one optical sun protection filter comprising at least one liquid crystal cell.

It is proposed that the optical sun protection filter comprises at least one photochromatic protection element, the transmittance of which changes in particular at least depending on solar irradiation. Advantageously, a high adaptability of a sun protection device to solar irradiation can be ensured. Another advantage is that protection against solar irradiation can be ensured in a particularly simple manner. A particularly high level of comfort for the wearer of the sun protection device is a further advantage.

The photochromatic protection element is preferably transparent. The term “photochromatic protection element” is to be understood in particular as a photochromatic lens, a photochromatic layer or the like. Preferably, this is to be understood as an element whose transmittance depends on the incidence of light, in particular solar irradiation. Preferably, the photochromatic protection element is designed to darken, in particular to darken automatically, with increasing incidence of light, in particular increasing solar irradiation, so that in particular the transmittance of the photochromatic protection element is reduced. As a particular preference, the photochromatic protection element is designed to brighten, preferably automatically, with falling incidence of light, in particular falling solar irradiation, onto the photochromatic protection element, so that in particular the transmittance of the photochromatic protection element is increased. In particular, the photochromatic protection element exhibits maximum transmittance in the absence of activating incidence of light onto the photochromatic protection element after a defined adaptation time. The defined adaptation time is preferably a maximum of 20 minutes, particularly preferably a maximum of 15 minutes. Preferably, the defined adaptation time depends on a material from which the photochromatic protection element is formed.

The photochromatic protection element can, for example, be formed at least in part by a base support which is preferably formed at least in part from glass, polycarbonate, cellulose triacetate or another suitable plastic, wherein, in particular in at least one illustrative embodiment, silver chloride molecules or the like are embedded in the base support. Alternatively or additionally, it is conceivable that organic photochromic molecules are embedded in the base support. It is also conceivable that the base support is formed by a component or element of the optical sun protection filter, for example by a polarisation layer of the optical sun protection filter or the like. The photochromatic protection element can be arranged, for example, as the outermost layer of the optical sun protection filter or at another position within the optical sun protection filter. Preferably, the photochromatic protection element is at least partially curved, in particular at least viewed in a main extension plane of the photochromatic protection element. A “main extension plane” of a unit or an element is to be understood in particular as a plane which is parallel to a largest side surface of a smallest possible imaginary cuboid which just completely encloses the unit, and in particular runs through the centre of the cuboid. Alternatively, however, it is also conceivable that the photochromatic protection element is designed without curvature, in particular at least viewed in the main extension plane of the photochromatic protection element.

Alternatively, it is also conceivable that the photochromatic protection element is formed as a coating or a film and is applied in particular to a carrier element. The carrier element can, for example, be formed by at least one component or element of the sun protection device, in particular by the liquid crystal cell, the polarisation layer and/or a cellulose triacetate layer of the optical sun protection filter. In at least one illustrative embodiment, the photochromatic protection element preferably lies on the carrier element. Particularly preferably, the photochromatic protection element is fixed to the carrier element. It is also conceivable that the carrier element is formed in one piece with the photochromatic protection element. In particular, “in one piece” should be understood to mean at least materially bonded, for example by a welding process, an adhesive process, an injection moulding process and/or another process which appears expedient to the person skilled in the art, and/or advantageously formed in one piece, such as by a production from a casting and/or by a production in a single-component or multi-component injection moulding process and advantageously from a single blank. Alternatively or additionally, it is also conceivable that the photochromatic protection element is contained in an adhesive which is intended to bond at least two components or elements of the optical sun protection filter to one another. The photochromatic protection element is preferably arranged on the liquid crystal cell. The photochromatic protection element is preferably adjoining the liquid crystal cell. Particularly preferably, the photochromatic protection element is fixed to the liquid crystal cell. It is also conceivable that the photochromatic protection element is formed in one piece with the liquid crystal cell. Alternatively, it is conceivable that at least one additional element, in particular at least one additional optical element of the optical sun protection filter, preferably at least one additional optical layer, is arranged between the photochromatic protection element and the liquid crystal cell. The photochromatic protection element and the liquid crystal cell preferably overlap at least partially, particularly preferably at least substantially in their entirety, at least as viewed along a transverse axis of the liquid crystal cell. By “at least substantially in their entirety” is to be understood in particular as at least 50%, preferably at least 75% and particularly preferably at least 90% of a total volume and/or a total mass of an object. The transverse axis of the liquid crystal cell is at least substantially perpendicular to a main extension plane of the liquid crystal cell. In use of the device, the liquid crystal cell and/or the photochromatic protection element is in particular looked through at least substantially parallel to the transverse axis. The term “substantially perpendicular” is intended here in particular to define an orientation of a direction relative to a reference direction, wherein the direction and the reference direction, in particular as viewed in a projection plane, enclose an angle of 90° and the angle has a maximum deviation of in particular less than 8°, advantageously less than 5° and particularly advantageously less than 2°. The term “substantially parallel” is meant here in particular to define an orientation of a direction relative to a reference direction, in particular in a plane, wherein the direction has a deviation relative to the reference direction of in particular less than 8°, advantageously less than 5° and particularly advantageously less than 2°. Preferably, the photochromatic protection element covers the liquid crystal cell at least partially, preferably at least substantially it its entirety, in particular at least viewed in a direction of a hypothetical incidence of light, particularly preferably in a direction of a hypothetical solar irradiation. The photochromatic protection element and the liquid crystal cell form in particular a part of a layer composite, wherein the photochromatic protection element and the liquid crystal cell each form superimposed layers. Alternatively, it is conceivable that the liquid crystal cell at least partially, preferably completely, covers the photochromatic protection element, preferably at least viewed in a direction of hypothetical light incidence, in particular in a direction of hypothetical solar irradiation. Furthermore, it is alternatively conceivable that the liquid crystal cell and the photochromatic protection element do not overlap, preferably at least viewed along the transverse axis of the liquid crystal cell. In at least one, in particular the preferred, illustrative embodiment, the optical sun protection filter may comprise at least two photochromatic protection elements. Preferably, each photochromatic protection element of the optical sun protection filter is associated with one eye of the user. In principle, however, it would also be conceivable for the optical sun protection filter to have only one photochromatic protection element for both eyes of the user.

Preferably, in this context, the photochromatic protection element, the liquid crystal cell and/or the optical sun protection filter should be understood as an optical element. In this context, the “transmittance” of an optical element is to be understood in particular as a degree of transmission of sunlight through the optical element. Preferably, this is to be understood in particular as the extent to which the visible spectrum of sunlight is absorbed and/or reflected by the optical element. Particularly preferably, this is to be understood to mean a tint.

In this context, a “sun protection device” is to be understood in particular as a device which is intended to protect the eyes of a user from, in particular disturbing, solar irradiation. Preferably, this is to be understood to mean in particular a device which is intended to at least reduce solar irradiation. Particularly preferably, the sun protection device is in at least one operating state configured for darkening, in particular disturbing, solar irradiation on the eyes of the user. Various designs of the sun protection device that appear expedient to a person skilled in the art are conceivable, such as a sunshade, sunglasses, ski goggles, motorbike goggles, safety goggles or the like. The term “intended to” here is meant in particular specifically programmed, designed and/or equipped. That an object is intended to perform a specific function is to be understood in particular as meaning that the object fulfils and/or performs this specific function in at least one application and/or operating state.

Furthermore, in this context, “optical sun protection filter” is to be understood to mean in particular an optical filter which forms in particular a protective glass and/or a plastic protective glass, in particular for protection against disturbing solar irradiation. Preferably, this is to be understood in particular as an optical protective filter with automatic darkening. Particularly preferably, the sun protection filter has at least one liquid crystal plane with switchable transmission. In at least one, in particular a preferred, illustrative embodiment, the optical sun protection filter may comprise at least two liquid crystal cells. Preferably, each liquid crystal cell of the optical sun protection filter is assigned to a specific eye of the user. In principle, however, it would also be conceivable for the optical sun protection filter to have only one liquid crystal cell for both eyes of the user. Various liquid crystal cells that appear expedient to a person skilled in the art are conceivable, such as in particular a TN liquid crystal cell with twisted nematic technology or a liquid crystal cell with 4DFFS technology. In principle, however, other liquid crystal cell designs that appear expedient to a person skilled in the art would also be conceivable, such as STN liquid crystal cells with the super twisted nematic technology, DSTN liquid crystal cells with the double super twisted nematic technology, TSTN liquid crystal cells with the triple super twisted nematic technology, VA-liquid crystal cells with the vertical alignment technique, in particular PVA/MVA-liquid crystal cells with the patterned vertical alignment and/or multi-domain vertical alignment technique, IPS-liquid crystal cells with the in-plane switching technique, FLCD-liquid crystal cells, i.e. ferroelectric liquid crystal cells, and/or TN-liquid crystal cells with the guest-host technique. Preferably, the liquid crystal cell is at least partially curved, in particular at least viewed in the main extension plane of the liquid crystal cell. However, it is also conceivable that the liquid crystal cell is formed without curvature, in particular at least viewed in the main extension plane of the liquid crystal cell.

Preferably, the sun protection device comprises at least one sensor unit which is configured at least for detecting solar irradiation. In this context, a “sensor unit” is to be understood in particular as a unit which is intended to record at least one characteristic variable and/or one physical property, wherein the recording can preferably take place actively, such as in particular by generating and transmitting an electrical measurement signal, and/or passively, such as in particular by recording changes in the properties of a sensor component. Various sensor units for a sun protection device are conceivable which appear expedient to a person skilled in the art. Preferably, the sensor unit comprises at least one photocell, in particular a photodiode and/or in particular a solar cell. Preferably, the photocell is configured at least for optical detection of sunlight and/or artificial light. The sensor unit can, for example, be arranged at least partially in a spectacle frame of the optical sun protection device, between the liquid crystal cell and the photochromatic protection element on the optical sun protection filter, as the outermost or innermost element of the sun protection device on the optical sun protection filter, in particular at least viewed along a direction of hypothetical light incidence, particularly preferably in a direction of hypothetical solar irradiation and/or at least partially at further or different positions of the optical sun protection device.

Preferably, the sun protection device comprises at least one control and/or regulating unit, which is configured at least for controlling and/or regulating a transmittance of the liquid crystal cell depending on solar irradiation. In this context, a “control and/or regulating unit” is to be understood in particular as a unit with at least one control electronics unit. A “control electronics unit” is to be understood here in particular as a unit with at least one electronic circuit, which preferably consists of voltage and comparison control components. In principle, however, the control electronics can also have a more complex structure, such as in particular comprising an application-specific integrated circuit (ASIC) and/or a microcontroller component. It is conceivable that the control and/or regulating unit is configured in at least one operating state for controlling the at least one liquid crystal cell of the optical sun protection filter to generate a transmittance profile defined for a user with at least two different transmittances. In this context, a “defined transmittance profile” is to be understood in particular as a local profile of a transmittance of the liquid crystal cell that is visible to a user, in particular a wearer.

It is also proposed that the optical sun protection filter has a total transmittance which is formed by at least one, in particular the aforementioned, transmittance of the liquid crystal cell and the transmittance of the photochromatic protection element. Advantageously, a particularly high protection against solar irradiation can be realised. Advantageously, a particularly high adaptability of the sun protection device to solar irradiation can be ensured. Preferably, the optical sun protection filter has a maximum total transmittance at the maximum transmittance of the photochromatic protection element and at a maximum transmittance of the liquid crystal cell. Preferably, the optical sun protection filter has a minimum total transmittance at a minimum transmittance of the photochromatic protection element and at a minimum transmittance of the liquid crystal cell. Preferably, the transmittance of the liquid crystal cell is adjustable depending on the transmittance of the photochromatic element. Preferably, the transmittance of the liquid crystal cell is adjustable by means of the control and/or regulating unit depending on the transmittance of the photochromatic protection element. Alternatively or additionally, it is also conceivable that the transmittance of the liquid crystal cell is adjustable independently of the transmittance of the photochromatic protection element. In at least one illustrative embodiment, it is alternatively conceivable that the transmittance of the photochromatic protection element depends on the transmittance of the liquid crystal cell. The maximum transmittance of the liquid crystal cell is preferably different from the maximum transmittance of the photochromatic protection element, in particular smaller or larger. Alternatively, it is also conceivable that the maximum transmittance of the photochromatic protection element corresponds to the maximum transmittance of the liquid crystal cell. It is conceivable that the minimum transmittance of the photochromatic protection element is different from, in particular greater or smaller, or equal to the transmittance of the liquid crystal cell. Preferably, the photochromatic protection element and/or the liquid crystal cell are/is tint-free at the maximum transmittance. Alternatively, it is conceivable that the photochromatic protection element and/or the liquid crystal cell each has/have a base tint at the maximum transmittance.

Furthermore, it is proposed that the sun protection device has an, in particular, curved protective layer, which is arranged as the outermost layer on the optical sun protection filter, wherein the photochromatic protection element is applied on the protective layer or is embedded in the protective layer. Advantageously, a particularly high protection of a carrier of the sun protection device can be ensured. Advantageously, a particularly robust optical sun protection filter can be realised. Preferably, the protective layer forms the carrier element or the base carrier for the photochromatic protection element. In particular, the protective layer is formed as a cellulose triacetate layer. However, it is also conceivable that the protective layer is formed from another material which appears expedient to the person skilled in the art. In principle, it is also conceivable that the protective layer is arranged at a different position on the optical sun protection filter. The protective layer is preferably configured to protect at least the optical sun protection filter from damage, in particular from damage by fats, oils, aromatic hydrocarbons, solvents and/or the like.

The protective layer may, for example, be curved or curvature-free. Preferably, the protective layer is at least partially curved, in particular at least viewed in a main extension plane of the protective layer. Preferably, the main extension plane of the protective layer in at least one illustrative embodiment, in particular in which the photochromatic protection element is placed on the protective layer, runs at least substantially parallel to a main extension plane of the photochromatic protection element. Particularly preferably, a curvature of the protective layer is at least substantially identical to a curvature of the photochromatic protection element. In this context, a “curvature” at a point on a surface which is different from zero is to be understood in particular as a deviation which increases quadratically with a distance from the point on the surface. Preferably, the protective layer covers the liquid crystal cell and/or the photochromatic protection element at least partially, preferably completely, in particular at least viewed along a direction of a hypothetical incidence of light, particularly preferably in a direction of a hypothetical solar irradiation. In at least one illustrative embodiment, the photochromatic protection element is arranged between the protective layer and the liquid crystal cell. However, in at least one further illustrative embodiment it is conceivable that the protective layer is arranged between the photochromatic protection element and the liquid crystal cell, wherein the protective layer is in particular at least partially, preferably completely, covered by the photochromatic protection element, preferably at least viewed in a direction of a hypothetical light incidence, in particular in a direction of a hypothetical solar irradiation.

It is further proposed that the optical sun protection filter comprises at least one polarisation layer, in particular the aforementioned polarisation layer, wherein the photochromatic protection element, in particular in at least one illustrative embodiment, is applied on the polarisation layer or is embedded in the polarisation layer. Advantageously, a particularly high protection of a carrier of the sun protection device can be ensured. Advantageously, the photochromatic protection element can be integrated into the sun protection device in a particularly space-saving manner. The polarisation layer can be curved or curvature-free. Preferably, the polarisation layer is at least partially curved, in particular at least viewed in a main extension plane of the polarisation layer. Preferably, in at least one illustrative embodiment, in particular in which the photochromatic protection element is applied on the polarisation layer, the main extension plane of the polarisation layer runs at least substantially parallel to the main extension plane of the photochromatic protection element. Particularly preferably, a curvature of the polarisation layer is at least substantially identical to a curvature of the photochromatic protection element. Preferably, the polarisation layer covers the liquid crystal cell and/or the photochromatic protection element at least partially, preferably completely, in particular at least viewed along a direction of a hypothetical light incidence, particularly preferably in a direction of a hypothetical solar irradiation.

It is further proposed that the sun protection device, in particular at least in one illustrative embodiment, comprises a sensor unit, in particular the aforementioned sensor unit, and a sensor cover, wherein the sensor cover at least partially covers a sensor surface of the sensor unit and is at least partially formed of a photochromatic material. Advantageously, a high degree of accuracy can be ensured when adapting the optical sun protection filter to solar irradiation, while at the same time ensuring a particularly high level of robustness of the sun protection device. In this context, a “sensor cover” is to be understood in particular as an element which at least partially covers, in particular overlaps, the sensor unit, preferably in a detection direction of the sensor unit. Preferably, this is to be understood as an element which at least partially covers, in particular covers over, the sensor surface of the sensor unit. Preferably, this is to be understood as a cover which at least partially covers over the sensor unit, preferably in a detection direction of the sensor unit, in particular for protection, such as against impacts or the like. Particularly preferably, this is to be understood as a cover which at least partially covers the sensor unit, preferably in a detection direction of the sensor unit, in particular in order to integrate the sensor unit so that it is invisible to an observer from the outside. Furthermore, in this context a “sensor surface” of the sensor unit is to be understood in particular as a detection surface of the sensor unit. Preferably, this is to be understood as a surface of the sensor unit on which the sensor unit can detect an incidence of light, in particular solar irradiation. Particularly preferably, this is to be understood as a cell surface of the sensor unit. Preferably, the sensor surface is directed forwards, i.e. in particular in the direction of a hypothetical viewing direction of a user. Preferably, the sensor surface extends substantially parallel to a front side of the sun protection device. In this context, “the sensor cover at least partially covers the sensor surface of the sensor unit” means in particular that at least 10%, preferably at least 30%, and particularly preferably at least 50% of all surface normal of the sensor surface intersect the sensor cover in a direction pointing away from the sensor unit. Preferably, the sensor cover is made of a material which corresponds to the material of the photochromatic protection element. Preferably, the sensor cover is arranged at a distance from the photochromatic protection element. Alternatively, it is conceivable that the sensor cover is formed by the photochromatic protection element. In particular, the sensor cover has a maximum thickness, preferably at least viewed along a transverse axis of the sensor cover, which corresponds to a maximum thickness of the photochromatic protection element, at least viewed along a transverse axis of the photochromatic protection element. Preferably, the transverse axis of the sensor cover is at least substantially perpendicular to a main extension plane of the sensor cover. Preferably, the transverse axis of the photochromatic protection element is at least substantially perpendicular to the main extension plane of the photochromatic protection element. Alternatively, it is also conceivable that the sensor cover is formed from a photochromatic material that is different from a material from which the photochromatic protection element is formed. Alternatively, it is conceivable that the maximum thickness of the sensor cover, preferably at least viewed along the transverse axis of the sensor cover, is different from the maximum thickness of the photochromatic protection element, preferably at least viewed along the transverse axis of the photochromatic protection element. Preferably, a transmittance of the sensor cover corresponds to the transmittance of the photochromatic protection element. Preferably, a dependence of the transmittance of the sensor cover on the solar irradiation corresponds to a dependence of the transmittance of the photochromatic protection element on the solar irradiation.

It is further proposed that the sun protection device, in particular at least in one illustrative embodiment, comprises a sensor unit, in particular the aforementioned sensor unit, which is arranged at least partially between the photochromatic protection element and the liquid crystal cell. Advantageously, a particularly simple structure of the sun protection device can be realised with a simultaneously particularly high accuracy of adaptation of the optical sun protection filter to solar irradiation. Preferably, the sensor unit is configured to detect solar irradiation after it passes the photochromatic protection element. Preferably, a sensor surface, in particular the aforementioned sensor surface, at least partially overlaps with the photochromatic protection element, at least when viewed along the transverse axis of the photochromatic protection element. Preferably, the photochromatic protection element covers the sensor surface at least partially, preferably completely, in particular at least as viewed in a detection direction of the sensor unit.

It is further proposed that the sun protection device comprises a spectacle frame, in particular the aforementioned spectacle frame, which is configured for receiving the optical sun protection filter. Advantageously, an implementation of the sun protection device can be achieved. Advantageously, a sun protection device can be provided which can be reliably placed on a users face. Advantageously, a spectacle-like implementation of the sun protection device can be provided. Preferably, the spectacle frame has at least one, preferably at least two, receiving area(s), each of which is/are configured for receiving a liquid crystal cell and/or a photochromatic protection element of the optical sun protection filter. In this context, a “spectacle frame” is to be understood in particular as a frame which is configured for arranging the sun protection device on a users face. Preferably, the frame is configured for an arrangement of the sun protection device on a nose and the ears of the user. Particularly preferably, the spectacle frame is formed by a spectacle rack. It is conceivable that the sensor cover, in particular at least in one illustrative embodiment, is formed in one piece with the spectacle frame.

Furthermore, the invention proceeds from a method for operating a sun protection device, in particular the aforementioned sun protection device. It is proposed that the transmittance of the liquid crystal cell is adjusted in at least one method step at least in dependence on the transmittance of the photochromatic protection element. Advantageously, a particularly precise adaptation of an optical sun protection filter to solar irradiation can be achieved. Advantageously, a high degree of comfort for a user of the sun protection device can be realised. Preferably, the transmittance of the liquid crystal cell is adjusted in at least one method step depending on the solar irradiation. Preferably, the transmittance of the liquid crystal cell is adjusted and/or regulated at least in the method step depending on the solar irradiation by means of the control and/or regulating unit. It is conceivable that the liquid crystal cell of the optical sun protection filter is controlled and/or regulated to generate a transmittance curve defined for a user. The solar irradiation is preferably detected by means of the sensor unit. The solar irradiation is preferably detected after passing the photochromatic protection element. It is also conceivable, in particular in at least one illustrative embodiment, that the solar irradiation is detected after passing the sensor cover.

Furthermore, a method for manufacturing a sun protection device, in particular the sun protection device mentioned above, is proposed. Preferably, in at least one method step, the photochromatic protection element and the liquid crystal cell are manufactured in one piece in an injection moulding process. Preferably, in at least one method step, the photochromatic protection element and the protective layer are manufactured in one piece in an injection moulding process. Alternatively or additionally, the sensor cover and the spectacle frame are manufactured in one piece in an injection moulding process in at least one method step. Advantageously, a particularly simple production of the sun protection device can be realised.

The sun protection device according to the invention, the method for operating a sun protection device according to the invention and/or the method for manufacturing a sun protection device according to the invention are/is not intended to be limited to the application and embodiment described above. In particular, the sun protection device according to the invention, the method for operating a sun protection device according to the invention and/or the manufacture of a sun protection device according to the invention may/can have a number of individual elements, components and units as well as method steps deviating from a number mentioned herein in order to fulfil a mode of operation described herein. Furthermore, for the ranges of values indicated in the present disclosure, values lying within the said limits are also to be regarded as disclosed and as usable as desired.

### DRAWINGS

Further advantages can be seen in the following graphic description. The drawings show two illustrative embodiments of the invention. The drawings, the description and the claims contain numerous features in combination. The person skilled in the art will practicably also consider the features individually and combine them to form useful further combinations.

The following are also shown:

FIG. 1 Sun protection device according to the invention in a first embodiment and a user wearing the sun protection device according to the invention in a schematic frontal view,

FIG. 2 a partial section of the sun protection device according to the invention with an optical sun protection filter in a schematic sectional view,

FIG. 3 a schematic sequence of a method according to the invention for operating the sun protection device according to the invention,

FIG. 4 a schematic sequence of a method according to the invention for manufacturing the sun protection device according to the invention,

FIG. 5 a sun protection device according to the invention in a second embodiment and a user wearing the sun protection device according to the invention in a schematic frontal view and

FIG. 6 a partial section of the sun protection device according to the invention in the second embodiment with an optical sun protection filter in a schematic sectional view.

### DESCRIPTION OF THE ILLUSTRATIVE EMBODIMENTS

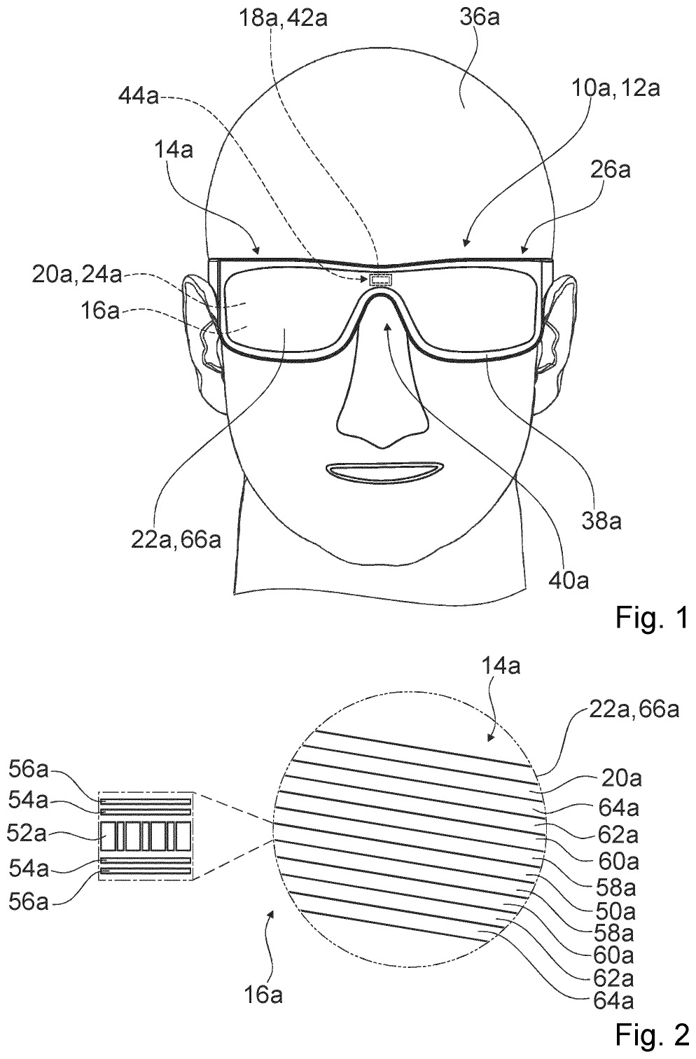

FIG. 1 shows a sun protection device 10a. The sun protection device 10a is formed by a pair of sunglasses 12a. Alternatively, it is also conceivable that the sun protection device 10a is formed as a sunshade screen, a pair of ski goggles, a pair of motorbike goggles, a pair of work goggles or the like. The sun protection device 12a automatically darkens in response to solar irradiation. In principle, however, another design of the sun protection device 10a that appears expedient to a person skilled in the art would also be conceivable. At least in one operating state, the sun protection device 10a is intended to darken solar irradiation on the eyes of a user 36a.

The sun protection device 10a comprises at least one spectacle frame 26a. The spectacle frame 26a is formed by a spectacle rack. The spectacle frame 26a is substantially made of plastic. In principle, however, another material that appears expedient to a person skilled in the art would also be conceivable, such as wood, metal and/or a fibre composite material. The spectacle frame 26a has a base frame 38a and two spectacle arms movably mounted on the base frame 38a. The base frame 38a has a nose cutout 40a for resting on the nose of a user 36a. The arms of the spectacles are each intended to rest on the ears of the user 36a. The base frame 38a consists of two frame parts. In principle, however, it would also be conceivable for the base frame 38a to be formed in one piece. The two frame parts are each formed by a shell part. A first frame part is arranged on a front side and a second frame part is arranged on a rear side. The frame parts are bonded together, sealing a cavity between the frame parts. Components arranged within the base frame 38a are inserted into the frame portions prior to bonding.

The sun protection device 10a comprises at least one optical sun protection filter 14a. The base frame 38a is configured for receiving the optical sun protection filter 14a. The optical sun protection filter 14a is received in the spectacle frame 26a. A light transmission of the optical sun protection filter 14a is adjustable. The optical sun protection filter 14a is substantially transparent, wherein a transmission of the optical sun protection filter 14a is at least partially electrically variable. The optical sun protection filter 14a has at least one liquid crystal cell 16a. The liquid crystal cell 16a is received in the spectacle frame 26a. The base frame 38a of the spectacle frame 26a has a recess in which the liquid crystal cell 16a is received.

The liquid crystal cell 16a has a liquid crystal plane 50a transmittance switchable in the transmission. The liquid crystal cell 16a of the optical sun protection filter 14a is formed by a plastic liquid crystal cell. The liquid crystal cell 16a consists of several layers (cf. FIG. 2). The number of layers is merely exemplary and can vary in principle. The liquid crystal cell 16a is formed by a TN liquid crystal cell. The liquid crystal cell 16a is therefore based on the twisted nematic technique. In principle, however, some other design of the liquid crystal cell 16a that would appear expedient to a person skilled in the art is also conceivable. The liquid crystal plane 50a is formed by a translucent liquid crystal plane. The liquid crystal plane 50a has a liquid crystal layer 52a. A plurality of crystal molecules and spacers are arranged in the liquid crystal layer 52a. A polyimide layer 54a is arranged on each side of the liquid crystal layer 52a. The polyimide layers 54a serve in particular to align the crystal molecules. An electrode layer 56a is arranged on each of the sides of the polyimide layers 54a facing away from the liquid crystal layer 52a. The electrode layers 56a are each formed by a transparent indium tin oxide layer. Furthermore, a polarisation layer 58a is located on each side of the liquid crystal layer 50a. The polarisation layers 58a each serve to polarise incident light. A disc 60a is arranged on each of the sides of the polarisation layers 58a facing away from the liquid crystal plane 50a. The discs 60a are made of polycarbonate. An anti-reflective layer 62a and a hard layer 64a are positioned on an outer surface of each of the panes 60a. The liquid crystal cell 16a of the optical sun protection filter 14a is curved over its entire length.

The optical sun protection filter 14a comprises at least one photochromatic protection element 20a. The photochromatic protection element 20a is received in the recess of the spectacle frame 26a. The photochromatic protection element 20a is formed as a coating or a film. The photochromatic protection element 20a is composed, at least in part, of silver chloride molecules, organic photochromatic molecules, and/or the like. The sun protection device 10a comprises at least one protective layer 22a which the photochromatic protection element 20a is applied on. Alternatively, it is conceivable that the photochromatic protection element 20a is embedded in the protective layer 22a. In principle, it is also conceivable that the photochromatic protection element 22a is embedded in/applied on another component or element of the optical sun protection filter 14a. Furthermore, it is alternatively conceivable that the photochromatic protection element 20a is contained in an adhesive which is intended to bond at least two components or elements of the optical sun protection filter 14a to one another. The protective layer 22a is formed as a cellulose triacetate layer 66a. However, it is also conceivable that the protective layer 22a is formed from another material that appears expedient to the person skilled in the art. The protective layer 22a is arranged as the outermost layer on the optical sun protection filter 14a (cf. FIG. 2). In principle, it is also conceivable that the protective layer 22a is arranged at another position within the optical sun protection filter 14a. The protective layer 22a is intended to protect at least the optical sun protection filter 14a from damage, in particular from damage caused by greases, oils, aromatic hydrocarbons, solvents and/or the like. The protective layer 22a is curved, although it is in principle also conceivable, in particular, that the protective layer 22a is curvature-free, at least as viewed in a main extension plane of the protective layer 22a. The main extension plane of the protective layer 22a runs at least substantially parallel to a main extension plane of the photochromatic protection element 20a. The curvature of the protective layer 22a is at least substantially identical to a curvature of the photochromatic protection element 20a. The transmittance of the photochromatic protection element 20a changes at least depending on the solar irradiation. The photochromatic protection element 20a is transparent and formed as a photochromatic layer. The photochromatic protection element 20a is configured to darken automatically with increasing incidence of light, in particular solar irradiation, so that the transmittance of the photochromatic protection element 20a is reduced. The photochromatic protection element 20a is at least configured to lighten with falling solar irradiation, so that the transmittance of the photochromatic protection element 20a is increased. The photochromatic protection element 20a exhibits maximum transmittance in the absence of activating light incidence on the photochromatic protection element 20a after a defined adaptation time. The defined adaptation time is a maximum of 15 minutes. The defined adaptation time depends on a material from which the photochromatic protection element 20a is formed.

The photochromatic protection element 20a is arranged on the liquid crystal cell 16a (cf. FIG. 2). The photochromatic protection element 20a is in contact with the liquid crystal cell 16a. The photochromatic protection element 20a is fixed toto the liquid crystal cell 16a. It is also conceivable that the photochromatic protection element 20a is formed in one piece with the liquid crystal cell 16a. Alternatively, it is conceivable that at least one additional element, in particular at least one additional optical element of the optical sun protection filter 14a, preferably at least one additional optical layer, is arranged between the photochromatic protection element 20a and the liquid crystal cell 16a. The photochromatic protection element 20a overlaps the liquid crystal cell 16a at least substantially in its entirety, at least as viewed along a transverse axis of the liquid crystal cell 16a. The transverse axis of the liquid crystal cell 16a is at least substantially perpendicular to a main extension plane of the liquid crystal cell 16a. When the device is in use, the liquid crystal cell 16a and the photochromatic protection element 20a are at least viewed substantially parallel to the transverse axis. The photochromatic protection element 20a covers the liquid crystal cell 16a at least substantially in its entirety, at least when viewed in a direction of hypothetical solar irradiation. The photochromatic protection element 20a and the liquid crystal cell 16a form part of a layered composite, wherein the photochromatic protection element 20a and the liquid crystal cell 16a each form superimposed layers.

The protective layer 22a covers the liquid crystal cell 16a and the photochromatic protection element 20a at least partially, preferably completely, at least when viewed along a direction of hypothetical light incidence, particularly preferably in a direction of hypothetical solar irradiation. The photochromatic protection element 20a is arranged between the protective layer 22a and the liquid crystal cell 16a. However, in at least one further illustrative embodiment, it is conceivable that the protective layer 22a is arranged between the photochromatic protection element 20a and the liquid crystal cell 16a, wherein the protective layer 22a is in particular at least partially, preferably completely, covered by the photochromatic protection element 20a, at least as viewed in a direction of hypothetical light incidence, in particular in a direction of hypothetical solar irradiation.

Furthermore, the sun protection device 10a comprises a sensor unit 18a. The sensor unit 18a is configured for detecting solar irradiation. The sensor unit 18a has a sensor surface 42a, which is configured for detecting solar irradiation. The sensor unit 18a has one or more photodiodes, which is/are formed by a photocell. In principle, however, it would also be conceivable for the sensor unit 18a to have, for example, a solar cell. Furthermore, it would be conceivable, for example, that at least part of the sensor unit 18a, such as individual photodiodes, are arranged as strips in an end region of the sun protection device 10a.

Furthermore, the sun protection device 10a comprises at least one control and/or regulating unit 44a. The control and/or regulating unit 44a is configured for controlling a transmittance of the optical sun protection filter 14a depending on the solar irradiation. For this purpose, the control and/or regulating unit 44a is not visibly connected to the sensor unit 18a. Furthermore, the control unit 44a is not visibly connected to the liquid crystal cell 16a of the optical sun protection filter 14a. The control and/or regulating unit 44a is not further shown electrically connected to the electrode layers 56a of the liquid crystal cell 16a. The control and/or regulating unit 44a is arranged in the spectacle frame 26a. The control and/or regulating unit 44a is arranged in the base frame 38a of the spectacle frame 26a above the nose cutout 40a. The control and/or regulating unit 44a is integrated in the spectacle frame 26a. The control and/or regulating unit 44a is arranged in a receiving area of the base frame 38a. The receiving area of the base frame 38a is arranged above the nose cut-out 40a. The receiving area of the base frame 38a is formed by a recess. In principle, however, another arrangement of the control and/or regulating unit 44a that appears expedient to a person skilled in the art would also be conceivable.

In an operating state, the sensor unit 18a is configured for at least partially providing energy for an actuation of the liquid crystal cell 16a of the optical sun protection filter 14a. During operation of the sun protection device 10a, the sensor unit 18a is configured for complete supply of the energy for actuating the liquid crystal cell 16a of the optical sun protection filter 14a. The sensor unit 18a is configured during an operation of the sun protection device 10a for a complete generation of the energy required for the actuation of the liquid crystal cell 16a of the optical sun protection filter 14a. The sun protection device 10a is battery-free.

The optical sun protection filter 14a has a total transmittance formed by at least a transmittance of the liquid crystal cell 16a and the transmittance of the photochromatic protection element 20a. At a maximum transmittance of the photochromatic protection element 20a and at a maximum transmittance of the liquid crystal cell 16a, the optical sun protection filter 14a shows maximum total transmittance. The transmittance of the liquid crystal cell 16a is adjustable depending on the transmittance of the photochromatic protection element 20a. The transmittance of the liquid crystal cell 16a is adjustable by means of the control and/or regulating unit 44a depending on the transmittance of the photochromatic protection element 20a. Alternatively or additionally, it is also conceivable that the transmittance of the liquid crystal cell 16a is adjustable independently of the transmittance of the photochromatic protection element 20a. The maximum transmittance of the liquid crystal cell 16a is different from the maximum transmittance of the photochromatic protection element 20a, in particular smaller or greater. Alternatively, it is also conceivable that the maximum transmittance of the liquid crystal cell 16a corresponds to the maximum transmittance of the photochromatic protection element 20a.

This applies analogously to the minimum transmittances of the liquid crystal cell 16a and the photochromatic protection element 20a. The photochromatic protection element 20a and the liquid crystal cell 16a are tint-free at the maximum transmittance. Alternatively, it is conceivable that the photochromatic protection element 20a and/or the liquid crystal cell 16a have/has a basic tint at the maximum transmittance.

The sensor unit 18a is at least partially arranged between the photochromatic protection element 20a and the liquid crystal cell 16a. The sensor unit 18a is configured at least to detect solar irradiation after it passes the photochromatic protection element 20a. The sensor surface 42a at least partially overlaps with the photochromatic protection element 20a, at least when viewed along the transverse axis of the photochromatic protection element 20a. The photochromatic protection element 20a completely covers the sensor surface 42a, at least when viewed in a detection direction of the sensor unit 18a.

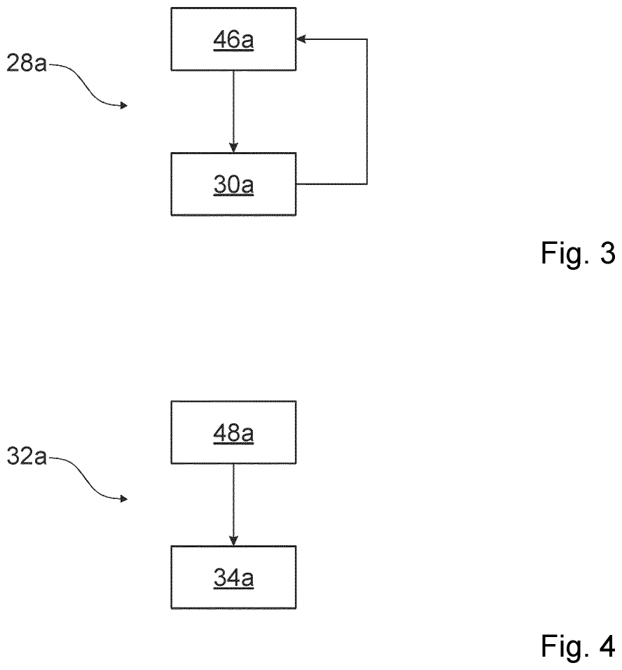

FIG. 3 shows a flowchart of a method 28a for operating the sun protection device 10a. In at least one method step 46a, solar irradiation is detected by means of the sensor unit 18a. In at least one method step 30a, the transmittance of the liquid crystal cell 16a is adjusted depending on the solar irradiation. The transmittance of the liquid crystal cell 16a is controlled and/or regulated at least in the method step 30a depending on the solar irradiation by means of the control and/or regulating unit 44a. It is conceivable that the liquid crystal cell 16a is controlled and/or regulated, at least in the method step 30a, for producing a transmittance profile defined for a user 36a. In at least the method step 30a, the transmittance of the liquid crystal cell 16a is adjusted at least in dependence on the transmittance of the photochromatic protection element 20a. The solar irradiation is detected at least in the method step 46a after passing the at least one photochromatic protection element 20a, in particular by means of the sensor unit 18a. FIG. 4 schematically shows a method 32a for manufacturing a sun protection device 10a. In at least one step 48a of the method 32a, a photochromatic protection element 20a is present separately from a liquid crystal cell 16a and/or from a protective layer 22a. In at least one further method step 34a, the photochromatic protection element 20a is applied on the protective layer 22a, in particular in a coating process, or is produced in one piece with the protective layer 22a. It is conceivable that the sensor unit 18a is overmoulded by the optical sun protection filter 14a at least in the method step 34a.

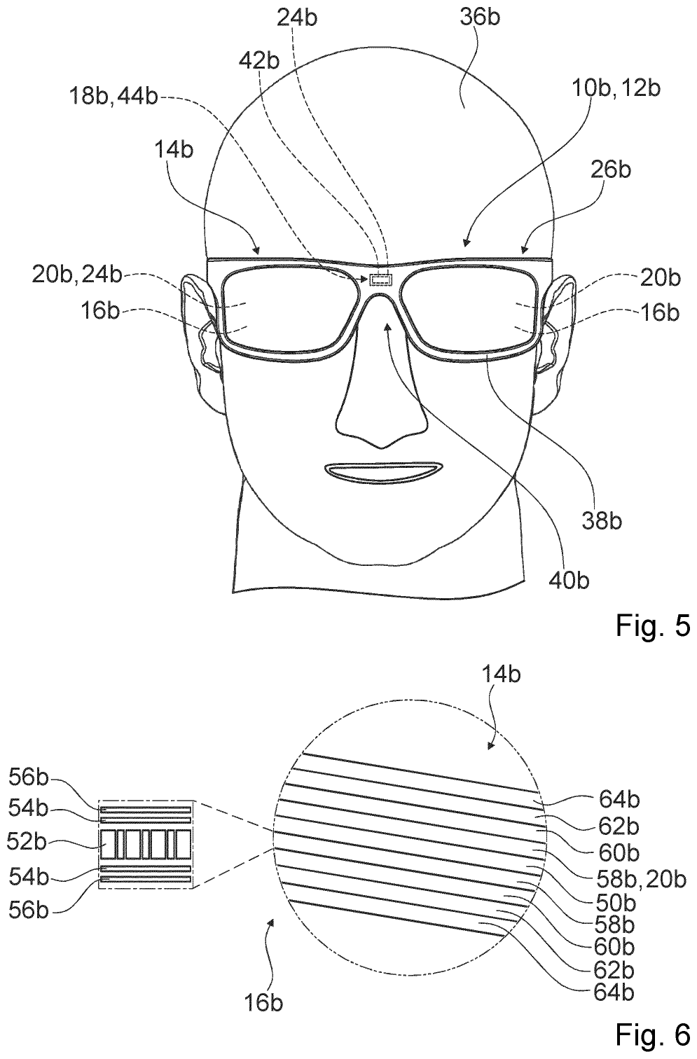

FIGS. 5 and 6 show a further illustrative embodiment of the invention. The following description and the drawing are essentially limited to the differences between the illustrative embodiments, whereby with regard to identically designated components, in particular with regard to components with the same reference signs, reference can in principle also be made to the drawings and/or the description of the other illustrative embodiment, in particular FIGS. 1 to 4. To distinguish between the illustrative embodiments, the letter “a” is placed after the reference signs of the illustrative embodiment in FIGS. 1 to 4. In the illustrative embodiment of FIGS. 5 and 6, the letter “a” is replaced by the letter “b”. In particular, the procedures for the further illustrative embodiment are analogous to the procedure described so far, although the procedures may differ from the illustrative embodiment described so far due to the differences described with respect to the technical design of the sun protection device of the further illustrative embodiment. FIG. 5 shows a sun protection device 10b. The sun protection device 10b is formed by a pair of sunglasses 12b. The sun protection device 10b comprises at least one frame 26b. The sun protection device 10b comprises at least one optical sun protection filter 14b. The optical sun protection filter 14b comprises two liquid crystal cells 16b. The liquid crystal cells 16b show mirror symmetry with respect to each other. The liquid crystal cells 16b are received in the spectacle frame 26b. A base frame 38b of the spectacle frame 26b has two recesses in which the liquid crystal cells 16b are received. The liquid crystal cells 16b are each positioned on opposite sides of a nose cutout 40b. Each of the liquid crystal cells 16b is assigned to a corresponding eye of a user 36b. The optical sun protection filter 14b comprises two photochromatic protection elements 20b. The photochromatic protection elements 20b are arranged analogously to the liquid crystal cells 16b. The transmittance of the photochromatic protection elements 20b changes in each case at least depending on the solar irradiation.

The photochromatic protection elements 20b are each arranged on one of the liquid crystal cells 16b. One of the photochromatic protection elements 20b overlaps with one of the liquid crystal cells 16b in each case at least substantially in its entirety, at least as viewed along a transverse axis of the corresponding liquid crystal cell 16b. The transverse axis of the relevant liquid crystal cell 16b is at least substantially perpendicular to a main extension plane of the corresponding liquid crystal cell 16b. The photochromatic protection elements 20b each cover one of the liquid crystal cells 16b at least substantially in its entirety, at least as viewed in a direction of the hypothetical solar irradiation. The photochromatic protection elements 20b are each at least partially curved, at least as viewed in a main extension plane of the corresponding photochromatic protection element 20b.

A control and/or regulating unit 44b is arranged in the base frame 38b of the spectacle frame 26b between the recesses for the liquid crystal cells 16b. The sun protection device 10b comprises at least one sensor unit 18b and a sensor cover 24b. The sensor cover 24b at least partially covers a sensor surface 42b of the sensor unit 18b. The sensor surface 42b extends at least substantially parallel to an end face of the sun protection device 10b. The sensor cover 24b covers the sensor surface 42b at least substantially in its entirety. The sensor unit 18b is arranged in the spectacle frame 26b. The sensor unit 18b is arranged in the base frame 38b of the spectacle frame 26b above the nose cutout 40b. The sensor unit 18b is integrated into the spectacle frame 26b. The base frame 38b of the spectacle frame 26b has a receiving area above the nose cutout 40b, which is formed by a recess. The sensor unit 18b is arranged in the receiving area of the base frame 38b. The sensor cover 24b covers the receiving area of the base frame 38b of the spectacle frame 26b. The sensor cover 24b is formed by a plate-shaped cover. The sensor cover 24b is at least partially formed of a photochromatic material. The sensor cover 24b is formed of a material corresponding to the material of the photochromatic protection elements 20b. The sensor cover 24b is positioned at a distance from the photochromatic protection element 20b. The sensor cover 24b has a maximum thickness, at least when viewed along a transverse axis of the sensor cover 24b, that corresponds to a maximum thickness of the photochromatic protection elements 20b, at least when viewed along a transverse axis of the corresponding photochromatic protection element 20b. The transverse axis of the sensor cover 24b is at least substantially perpendicular to a main extension plane of the sensor cover 24b. The different transverse axes of the photochromatic protection elements 20b are at least substantially perpendicular to a main extension plane of the corresponding photochromatic protection element 20b. Alternatively, it is conceivable that the maximum thickness of the sensor cover 24b, at least as viewed along the transverse axis of the sensor cover 24b, is different from the maximum thickness of the photochromatic protection elements 20b, at least as viewed along the relevant transverse axis of the photochromatic protection elements 20b. A transmittance of the sensor cover 24b corresponds to the transmittance of the photochromatic protection elements 20b. A dependence of the transmittance of the sensor cover 24b on the solar irradiation corresponds to the dependence of the transmittance of the photochromatic protection elements 20b on the solar irradiation.

The optical sun protection filter 14b comprises at least one polarisation layer 58b (cf. FIG. 6). At least one polarisation layer 58b is arranged on each of the liquid crystal cells 16b. The photochromatic protection elements 20b are each embedded in one of the polarisation layers 58b. Alternatively, it is also conceivable that the photochromatic protection elements 20b are each applied on one of the polarisation layers 58b. The polarisation layers 58b are at least partially curved, at least when viewed in a main extension plane of the corresponding polarisation layer 58b. However, it is also conceivable in principle that the polarisation layers 58b are formed without curvature. The polarisation layers 58b each cover the liquid crystal cells 16b at least partially, preferably completely, in particular at least viewed along a direction of a hypothetical incidence of light, particularly preferably in a direction of hypothetical solar irradiation.

1. A sun protection device, in particular sunglasses, having at least one optical sun protection filter which has at least one liquid crystal cell, wherein the optical sun protection filter has at least one photochromatic protection element whose transmittance changes in particular at least depending on the solar irradiation.

2. The sun protection device according to claim 1, wherein the optical sun protection filter has a total transmittance which is formed at least by a transmittance of the liquid crystal cell and the transmittance of the photochromatic protection element.

3. The sun protection device according to claim 1, comprising an, in particular, curved, protective layer which is arranged as the outermost layer on the optical sun protection filter, the photochromatic protection element being applied on the protective layer or being embedded in the protective layer.

4. The sun protection device according to claim 1, wherein the optical sun protection filter has at least one polarisation layer, wherein the photochromatic protection element is applied on the polarisation layer or is embedded in the polarisation layer.

5. The sun protection device according to claim 1, comprising a sensor unit and a sensor cover, wherein the sensor cover at least partially covers a sensor surface of the sensor unit and is at least partially formed from a photochromatic material.

6. The sun protection device according to claim 1, comprising a sensor unit that is at least partially arranged between the photochromatic protection element and the liquid crystal cell.

7. The sun protection device according to claim 1, comprising a spectacle frame configured for receiving the optical sun protection filter.

8. A method of operating a sun protection device according to claim 1.

9. The method according to claim 8, wherein the transmittance of the liquid crystal cell is adjusted in at least one method step at least in dependence on the transmittance of the photochromatic protection element.

10. A method for manufacturing a sun protection device according to claim 1.
